(19) United States
(12) Patent Application Publication
(10) Pub. No.: US 2016/0070972 A1
(43) Pub. Date: Mar. 10, 2016

(54) System and method for determining a pet breed from an image

(71) Applicant: Visage The Global Pet Recognition Company Inc., Vancouver (CA)

(72) Inventor: Daesik Jang, Vancouver (CA)

(21) Appl. No.: 14/849,236

(22) Filed: Sep. 9, 2015

Related U.S. Application Data
(60) Provisional application No. 62/048,687, filed on Sep. 10, 2014.

(51) Int. Cl. G06K 9/46; G06K 9/62; G06T 7/00; A01K 29/00; G06K 9/00

(52) U.S. Cl. CPC G06K 9/46; A01K 29/00; G06K 9/00369; G06T 7/0042; G06K 9/628; G06T 2207/10004; G06T 2207/20081

(57) ABSTRACT

An image of a pet's face may be processed in order to determine a type of breed of the pet. The processing of the pet's image uses a multi-agent classifier. The multi-agent classifier comprises a plurality of individually trained agents that each classify the image to identify the potential breed or breeds of the image. The predicted breeds from each of the agents are then combined into the final breed prediction.

### TECHNICAL FIELD

The current application relates to processing of images of pets, and in particular to processing images of pets in order to determine a breed of the pet.

### BACKGROUND

Processing of images to classify objects has numerous applications. One such application is the classification of pets within an image. The classification may identify a breed of the pet. Conventional approaches to breed classification attempt to find an optimum classifier and optimum visual features that can be used to classify all breeds accurately. However the diversity of visual characteristics across breeds make training an optimal classifier difficult.

### SUMMARY

It would be desirable to be able to identify a breed of a pet from an image using a single technique. The processing of the pet's image uses a multi-agent classifier. Each agent classifies the image to identify the potential breed or breeds of the image. Each agent may function on a hierarchical basis, in which a parent classifier classifies the images into sub-categories, followed by further sub-category classifiers classifying each sub-category into further, more narrowly defined sub-categories. The predicted breeds from each of the agents are then combined into a final breed prediction.

Disclosed herein is a method of determining a breed of a pet from an image comprising: receiving an image depicting a pet's face; processing the received image with a plurality of classification agents each trained with a respective, different classification algorithm to provide one or more probabilities associated with a breed identifier (ID) indicative of the pet's face being of a particular breed associated with the breed ID; and consolidating the plurality of probabilities from each of the classification agents to provide final probabilities that the pet's face is associated with respective breed IDs.

In a further embodiment, the method further comprises pre-processing the received image to normalize coloring of the image.

In a further embodiment, one or more of the classification agents comprise a hierarchical breed classifier for classifying the image as one of a plurality of potential breeds in a hierarchical fashion.

In a further embodiment, the hierarchical breed classifier comprises a root category and a plurality of sub-categories, the root classifier classifying the image as one of the sub-categories.

In a further embodiment, one or more of the plurality of sub-categories is associated with additional sub-categories.

In a further embodiment, each sub-category and additional sub-category, not associated with additional sub-categories, represents a single breed.

In a further embodiment, training of the hierarchical breed classifier generates a plurality of sub-categories based on a conditional probability of classification between an originally assigned breed ID and a predicted breed ID of an image. sub-category classifiers for each of the plurality of sub-categories generated in training the hierarchical breed classifier are trained using images associated with respective breed IDs of the sub-category.

In a further embodiment, each of the plurality of sub-categories generated in training the hierarchical breed classifier are further trained using images associated with respective breed IDs of the sub-category.

In a further embodiment, each of the plurality of sub-category classifiers uses a different classifier and different feature, said different classifier and different feature being respective to the particular sub-category.

In a further embodiment, the method further comprises: detecting a location of the pet's face within the image.

In accordance with the present disclosure, there is further provided a system for determining a breed of a pet from an image comprising: a processing unit for executing instructions; a memory unit for storing instructions, which when executed by the processing unit configure the system to: receive an image depicting a pet's face; process the received image with a plurality of classification agents each trained with a respective, different classification algorithm to provide one or more probabilities associated with a breed identifier (ID) indicative of the pet's face being of a particular breed associated with the breed ID; and consolidate the plurality of probabilities from each of the classification agents to provide final probabilities that the pet's face is associated with respective breed IDs.

In a further embodiment, the instructions further configure the system to pre-process the received image to normalize coloring of the image.

In a further embodiment, one or more of the classification agents comprise a hierarchical breed classifier for classifying the image as one of a plurality of potential breeds in a hierarchical fashion.

In a further embodiment, the hierarchical breed classifier comprises a root category and a plurality of sub-categories, the root classifier classifying the image as one of the sub-categories.

In a further embodiment, one or more of the plurality of sub-categories is associated with additional sub-categories.

In a further embodiment, training of the hierarchical breed classifier generates a plurality of sub-categories based on a conditional probability of classification between an originally assigned breed ID and a predicted breed ID of an image.

In a further embodiment, sub-category classifiers for each of the plurality of sub-categories generated in training the hierarchical breed classifier are trained using images associated with respective breed IDs of the sub-category.

In a further embodiment, each of plurality of sub-categories uses a respective classifier and feature vector for the particular sub-category.

In a further embodiment, the instructions further configure the system to detect a location of the pet's face within the image.

In accordance with the present disclosure, there is further provided a non-transitory computer readable medium storing instructions for execution by a processor to configure a system to: receive an image depicting a pet's face; process the received image with a plurality of classification agents each trained with a different respective classification algorithm to provide one or more probabilities associated with a breed identifier (ID) indicative of the pet's face being of a particular breed associated with the breed ID; and consolidate the plurality of probabilities from each of the classification agents to provide final probabilities that the pet's face is associated with respective breed IDs.

### BRIEF DESCRIPTION OF THE DRAWINGS

Embodiments are described herein with reference to the appended drawings, in which:

FIG. 1 depicts determining a pet breed from an image;

FIG. 2 depicts a system for determining a breed of a pet and training the breed classifier;

FIG. 3 depicts components for determining a breed of a pet from an image;

FIG. 4 depicts a method of determining a breed of a pet from an image;

FIG. 5 depicts a further method of classification with multiple agents;

FIG. 6 depicts a set of training images;

FIG. 7 depicts a method of training a multi-agent breed classifier; and

FIG. 8 depicts a method of generating sub-category sets of a classification agent.

### DETAILED DESCRIPTION

Glossary

Agent—refers to one of the classifiers in the multi-agent classifier that is disclosed herein. An agent may have multiple constituent classifiers.

Classifier—an image analysis machine that analyzes features of objects in the images to determine what class or group the object belongs in.

Category, Sub-Category—both refer to a breed or a group of breeds having similar facial features. A sub-category is narrower than the category from which it is derived. Sub-categories may be derived from other sub-categories. Category and sub-category may also refer to the classifier that classifies the category and sub-category respectively.

Feature—a visual characteristic in an image, such as a characteristic of a breed of pet.

Feature Vector—a set of numerical values used to represent a feature

Hierarchical Classifier—a classifier that classifies images by first classing them into a typically small number of subsets with a parent or root classifier, followed by subsequent classification of each of the subsets using different child or sub-category classifiers.

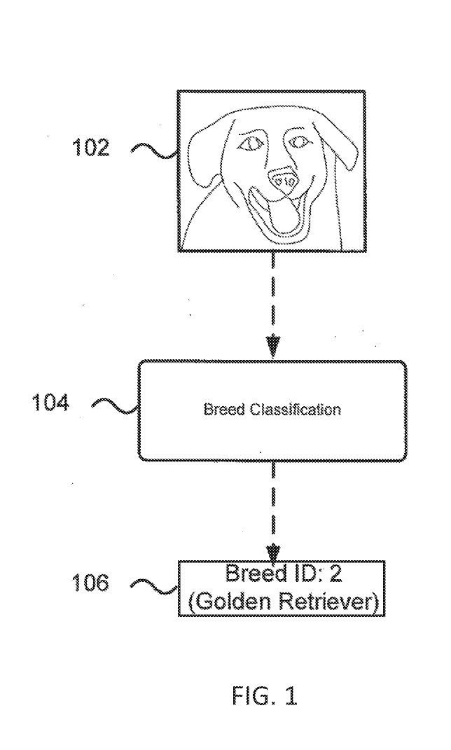

FIG. 1 depicts the breed classification process. An image of a pet 102 is processed by breed classification functionality 104 and provides an indication of the likely breed of the pet 106. The breed classification functionality 104 provides a single technique that can be applied to images of pets to determine a breed of the pet. As depicted, the breed classification functionality 104 may return a breed identifier (ID) that may be associated with a particular breed, such as a golden retriever. Although depicted as returning a single breed ID, it is possible for the breed classification functionality 104 to return a number of possible breeds, possibly with an associated probability for each breed. Determining a breed of a pet from an image may be achieved by processing an image of the pet using a multi-agent breed classifier. While previous classifiers have relied upon detected facial components, such as eyes, nose and mouth, in order to classify the breed of the pet, the current multi-agent breed classifier uses the whole face region for the classification. Accordingly, the multi-agent breed classifier does not suffer from unreliable facial component detection. As described further below, the multi-agent classifier uses a number of individual classification agents, each of which uses different classification algorithms and features to train and classify the image in parallel. The multiple agents can generate different classification results for the same image. The results from the multiple agents are combined into a final decision on the breed classification.

Each of the breed classification agents may be trained to construct a hierarchical classifier that may generate sub-categories of breeds in a hierarchical way. Each sub-category classifier may be trained with different classification algorithms and features that are selected based on the breeds in the particular sub-category, allowing each of the sub-category classifiers to focus on classifying the breeds in the sub-category. Accordingly, each agent attempts to classify an image in a hierarchical manner, by determining a sub-category and then using a classifier for the sub-category to possibly further classify the breed.

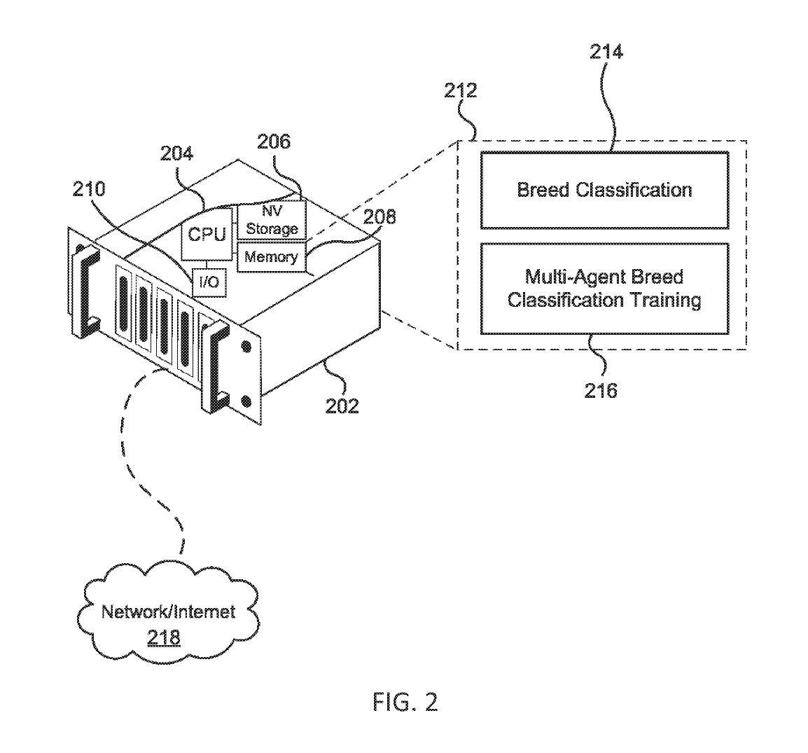

FIG. 2 depicts a system for determining a breed of a pet and training the breed classifier. As depicted, the system 202 comprises a central processing unit 204 for executing instructions. The system 202 may further comprise non-volatile (NV) storage for storing data and instructions in a non-volatile memory. The system 202 may further include a memory unit 208 that stores data and instructions for execution by the processing unit 204. The instructions and data stored in the memory unit 208 may be loaded from the non-volatile storage 206 and/or may be provided from other sources such as external components. The instructions stored in the memory unit 208 may be executed by the processing unit 204 in order to configure the system 202 to provide various functionalities 212, including the pet breed classification functionality 214 and the multi-agent breed classifier training functionality 216. The system 202 may further comprise an input/output (I/O) interface 210 that can connect the system 202 to other components, including for example a network interface for connecting to a network and/or the Internet 218, a keyboard, a mouse or pointing device, a monitor, a camera and/or other devices.

Although the above has depicted the pet breed classification functionality 214 and the multi-agent breed classifier training functionality 216 as being provided by a single physical system, it is contemplated that the functionality may be provided by separate systems. For example, a first system may provide training functionality in order to train the multi-agent breed classifier functionality, which may be subsequently loaded onto a second system for performing the breed classification on images. Further, the system 202, or any system implementing the functionalities 214, 216 may be provided as a number of physical or virtual servers or systems co-operating to provide required or desired processing loads, backup as well as redundancy. Further, although depicted as being provided in a computer server device, it is contemplated that the breed classification functionality 214, and possibly the training functionality 216 may be provided in other computing devices including for example personal computers, laptops, tablets and/or smart phones. Further still, breed classification functionality 214, and possibly the training functionality 216 may be provided in other devices, including, for example robotics, automotive vehicles, aviation vehicles or other devices that include a vision system.

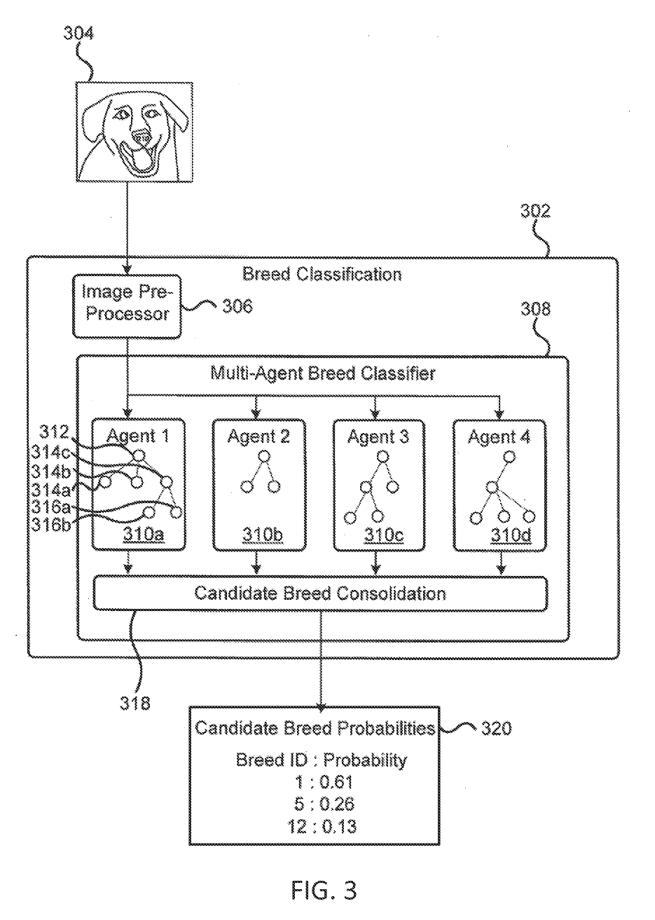

FIG. 3 depicts components for determining a breed of a pet from an image. The breed classification functionality 302 may be implemented in various systems including, for example, the system 202 described above in FIG. 2. The breed classification functionality 302 receives and processes an image of a pet's face 304 and provides candidate breed probabilities 320. The pet's face 304 may be identified from a larger image of the pet. The pet's face may be manually selected from a larger image by a user, or may be automatically detected. The breed classification functionality 302 may include image pre-processing functionality 306. The image pre-processing functionality 306 may include, for example, normalization functionality for normalizing the colour, size, orientation and/or other characteristics of the image. The pre-processed image may then be processed by the multi-agent breed classifier 308, in order to provide one or more candidate breed probabilities 320 indicative of the breed of the pet in the image 304.

As depicted, the multi-agent breed classifier 308 comprises a number of individual agents 310a, 310b, 310c, 310d (referred to collectively as agents 310). Each of the agents 310 is trained using different classification algorithms and features to classify the image. The agents 310 each process the image to provide an indication of possible breeds of the pet. The indication of the possible breeds may be provided as a breed ID and an associated probability. The breed ID may be an identifier, such as a number, that is associated with a particular breed. For example, a breed ID of 1 may be associated with a golden retriever, a breed ID of 2 may be associated with a German shepherd, etc. The probability associated with a particular breed ID calculated by a particular agent provides an indication of the likelihood that the pet is of the associated breed type. The multi-agent breed classifier 308 comprises candidate breed consolidation functionality 318 that receives the breed indications from each of the agents 310 and consolidates the plurality of indications into the final candidate breed probabilities 320.

Each of the agents 310 is trained to generate a hierarchy of category classifiers that are used in classifying images. With regard to Agent 1, 310a, the hierarchical classification is provided by a root category classifier 312 that classifies an image into one of a plurality of possible sub-categories 314a, 314b, 314c. The sub-categories 314a, 314b, 314c may be used to provide the breed indications, or may be used to further classify the image into additional sub-categories. As depicted, sub-categories 314a, 314b provide breed indications while sub-category 314c further classifies the image into additional sub-categories 316a, 316b. As depicted in FIG. 3, each of the agents 310 is trained using different algorithms and features and as such each of the agents provides a different hierarchical breed classifier. The number of individual agents used in the multi-agent classifier may vary, although four are depicted in FIG. 3.

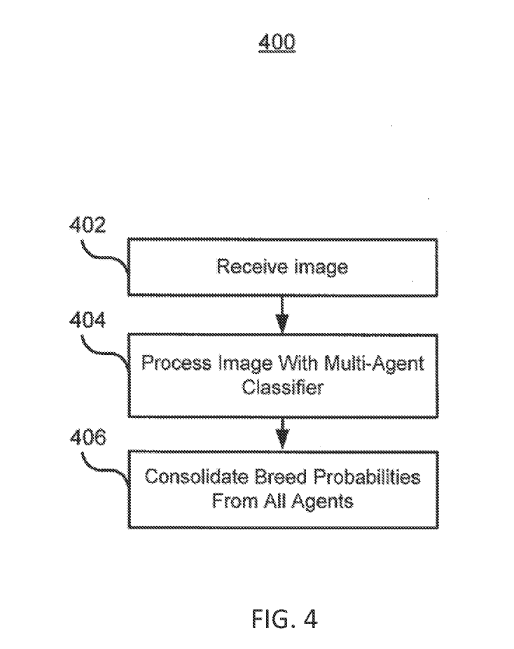

FIG. 4 depicts a method of determining a breed of a pet from an image. The method 400 receives an image (402). The received image is a face image of a pet that is to be classified. The image may be a sub-region of a larger image of the pet. Further, the received image may have been pre-processed in order to normalize the image, including for example the color of the image. The received image is processed by a plurality of breed classification agents (404). The processing by the agents may be done in parallel. Each of the respective agents is trained to classify pet breeds from images; however, each of the agents is trained using different algorithms and/or features and as such provides different classification results for the same image. The results from each of the agents provide one or more probabilities associated with a breed ID that provides an indication of the probability that the pet is of the particular breed. Once each of the agents has processed the image, the breed probabilities from all of the agents are consolidated together (406) in order to provide the final breed probabilities. All of the probabilities and associated breed IDs may be returned. Alternatively the probabilities returned may be based on a threshold. For example, the highest three probabilities may be returned, or all probabilities above a certain value may be returned.

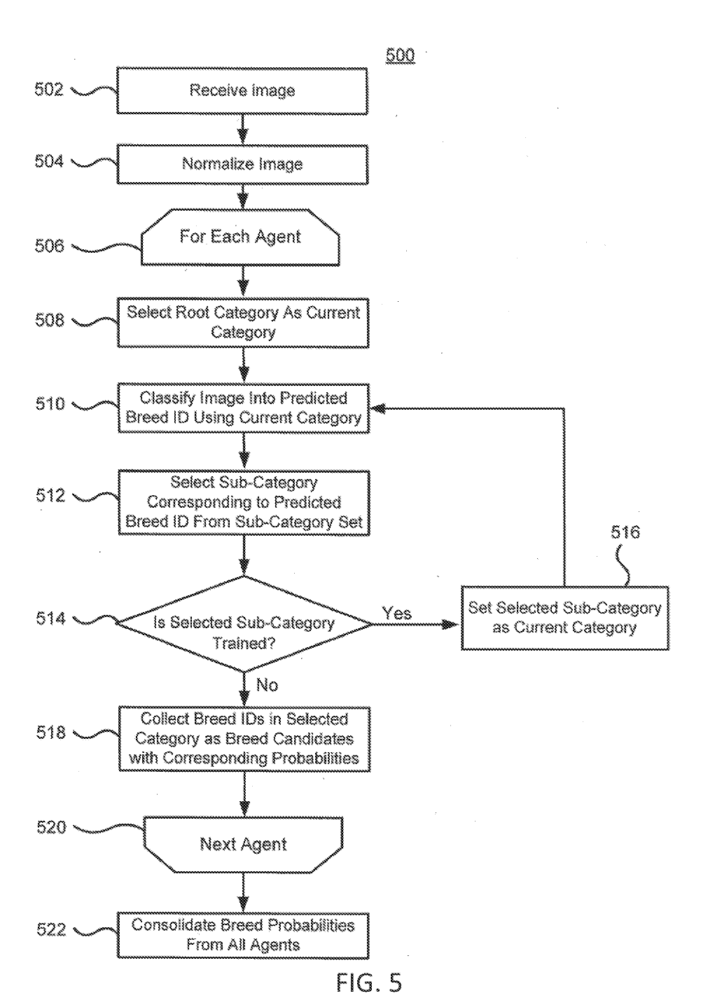

FIG. 5 depicts a further method of determining a breed of a pet from an image. The method 500 receives an image (502) of a pet's face, for which the breed is to be determined. The image is a frontal and upright image of the pet's face. The received image is processed to normalize the image (504). The image normalization may include, for example normalizing a size of the image, coloring of the image, or other characteristics. The normalized image is then processed by each of the agents (506) of the multi-agent classifier. Although the specific classifiers and features used by each agent differ, each processes the image in the same manner. Although the processing of the image by each agent is depicted in FIG. 5 as being sequential, the image may be processed by each agent in parallel. Each of the agents utilizes a hierarchical classifier for determining candidate breed probabilities for the image. The root category classifier of the hierarchical classifier is selected as the current category classifier (508) and used to classify the image into a predicted Breed ID (510). A sub-category classifier of the hierarchical classifier associated with the predicted breed ID is selected (512). It is determined whether the selected sub-category classifier has been trained (514) to further classify the image into lower sub-categories. If the sub-category classifier has been trained (Yes at 514), the classifier of the selected sub-category is set as the current category classifier (516) and the image further classified again using the current category classifier (510). If the sub-category classifier is not trained to further classify the image (No at 514), the breed IDs and associated probabilities are collected from the sub-category classifier (518). Each of the lowest sub-category classifiers in the hierarchical classifier have a number of breed IDs that it can classify with an associated probability that the image is the particular breed ID. The next agent (520) processes the image in the same manner, although the hierarchical breed classifier used by each agent differs. Once all of the agents have processed the image, the breed probabilities determined by each of the agents are consolidated (522). The consolidation merges the probabilities by summing probabilities together for matching breed IDs. The summed probabilities may then be normalized to probabilities by dividing by the sum of all of the probabilities, or may be used directly as a breed candidate score.

The candidate breed scores, or final candidate breed probabilities may all be returned or may be thresholded in order to return only the most relevant, or most likely breeds. The thresholding may return, for example, a predetermined number of the top breed candidates. Additionally or alternatively, all breed candidates above a particular threshold value may be returned.

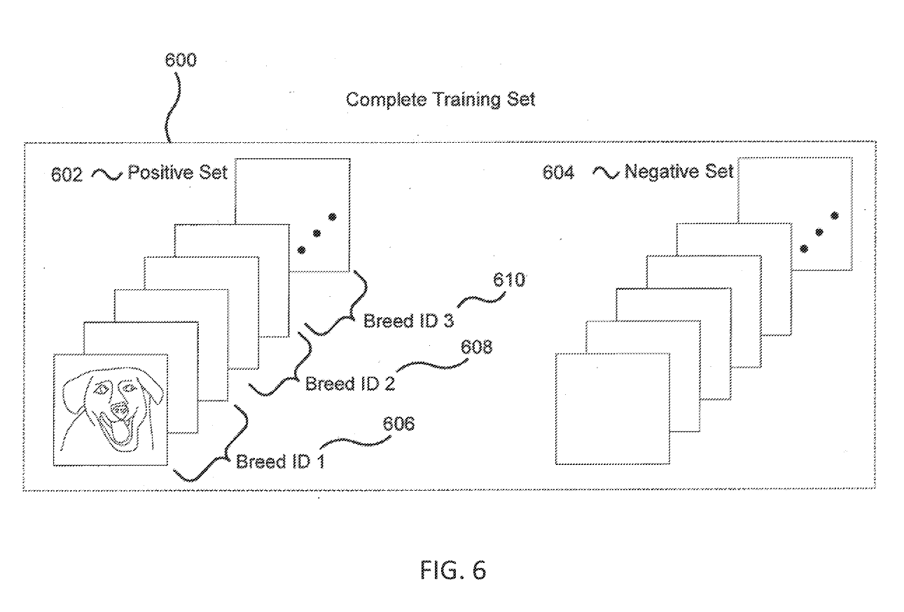

FIG. 6 depicts a set of training images. The complete training set 600 of images includes a number of images that include pet face images as well as non-pet face images. The pet face images comprise a positive training set 602 of images, and the non-pet face images comprise a negative training set 604 of images. The positive training set of images is further grouped by breed IDs 606, 608, 610 of the different breeds to be classified. The breed IDs and grouping of the positive training set images may be done manually.

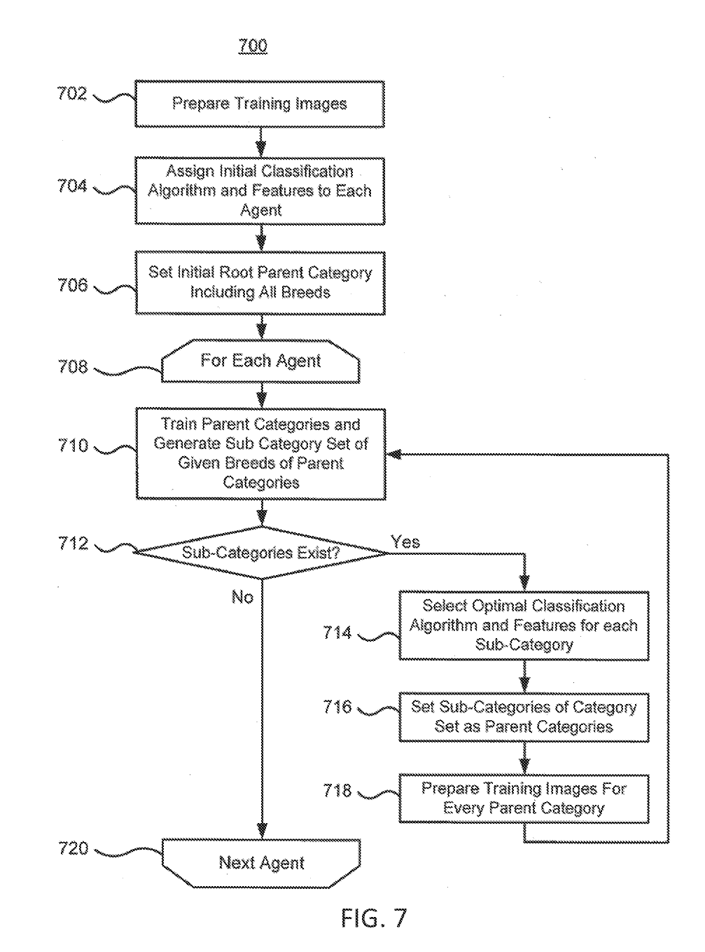

FIG. 7 depicts a method of training a multi-agent breed classifier. The method 700 trains the multi-agent breed classifier on a training set of images. The training images are prepared (702), which includes associating a breed ID with each of the images of a pet's face. Initial classification algorithms and features are assigned to each agent of the multi-agent breed classifier (704). As described above, each agent uses a different classification algorithm and feature set. The initial root or parent category of each of the agents is set (706). The root category of each agent is used in classifying images of all breeds, while sub-category classifiers will only process a sub-set of all of the breeds.

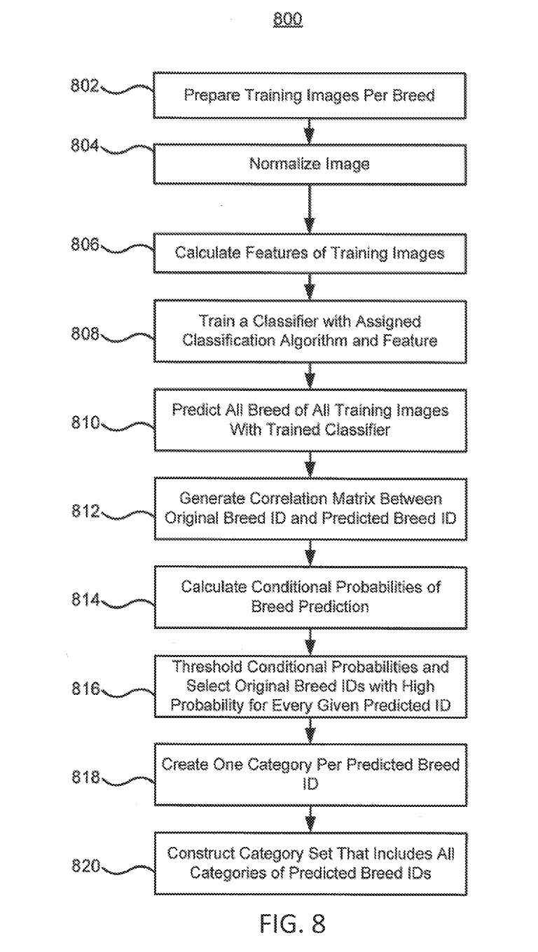

For each agent (708), the training process is the same. The parent classifier is trained on all images for the parent category and a sub-category set of breeds is generated from the parent category (710). In the case of the root category classifier, the images used are the images of all breeds, while in the case of a sub-category classifier, the images used may be only the images of the breeds that are in the sub-category. The training of a parent classifier and generation of sub-categories is further described with reference to FIG. 8. Once the parent classifiers are trained, it is determined whether there are any sub-categories (712). If there are no further categories (No at 712), the hierarchical classifier of the agent has been trained and the next agent may be trained (720). If there are sub-categories (Yes at 712), then each of the sub-categories are prepared and trained as a category. A classification algorithm and feature(s) are selected (714) for each of the sub-category classifiers. Predefined sets of candidate classification algorithms and features are evaluated with the images corresponding to each sub-category. A set of classification algorithm and feature(s) that has a highest classification accuracy for the sub-category images is selected. The sub-categories are then set as parent categories (716). The training images for each of the parent categories are prepared (718). The training images for each parent category include images associated with the breed IDs included in the parent category.

As described above, each of the agents is trained in a hierarchical fashion. As each agent is trained, sub-categories are generated and the hierarchical nature of the classifier is created. The hierarchical processing by the individual agents provides an efficient processing technique for classifying an image. Since each individual agent may use a hierarchical classification approach, which provides an efficient technique for classifying an image, it is computationally practical to utilize a plurality of agents to classify the image.

FIG. 8 depicts a method of training a category classifier of a classification agent. As described above, each agent comprises a root category classifier, which classifies an image into one of a plurality of sub-categories. Similarly, each sub-category classifier may in turn classify an image into one of a plurality of sub-categories. The sub-category classifiers may alternatively provide breed classification probabilities. The training of a category classifier is further described with reference to FIG. 8.

The training method 800 trains a classifier of a category that includes more than one breed. Once a classifier for a category is trained using the assigned classification algorithm and feature, the classifier classifies the training images into predicted breed IDs. The predicted breed IDs and the original, or actual, breed IDs are then used to generate sub-categories of the category, which in turn can be subsequently trained.

The method 800 prepares training images (802) for each breed in the category and normalizes the images (804). Although depicted as being part of the category classifier training, the preparation of the images and their normalization may have been already performed and may not be necessary again. Once the training images are prepared, feature vectors of the training images are calculated (806) based on the assigned visual feature for the classifier. The classifier is then trained to classify breed IDs using the assigned classification algorithm and calculated feature vectors (808).

Once trained, the classifier is used to predict the breed of all training images (810). Each of the images of the category will be associated with an original breed ID initially assigned to the image and a predicted breed ID determined by the classifier. If the classifier was perfect in the classification, the original breed ID and predicted breed ID would match for each image. However, in practice a number of images will have a mismatch between the original and predicted breed IDs. A correlation matrix is generated (812) between the original breed ID and the predicted breed ID determined by the classifier. The correlation matrix may be constructed by counting the number of classification pairs between original breed ID and predicted breed ID. For example M(Oj, Pi) is the number of images that have the original breed ID Oj, but were classified as the predicted breed ID Pi. The following table depicts an illustrative correlation matrix.

TABLE 1
Correlation Matrix

| | P1 | P2 | P3 | P4 | P5 | P6 | P7 | P8 | P9 |
|---|---|---|---|---|---|---|---|---|---|
| O1 | 16 | 0 | 0 | 1 | 2 | 4 | 1 | 3 | 3 |
| O2 | 1 | 19 | 1 | 5 | 1 | 1 | 2 | 0 | 0 |
| O3 | 0 | 0 | 24 | 0 | 3 | 0 | 0 | 1 | 2 |
| O4 | 0 | 0 | 0 | 30 | 0 | 0 | 0 | 0 | 0 |
| O5 | 1 | 1 | 5 | 3 | 16 | 3 | 0 | 1 | 0 |
| O6 | 1 | 2 | 0 | 0 | 3 | 20 | 3 | 1 | 0 |
| O7 | 4 | 0 | 0 | 0 | 1 | 1 | 22 | 2 | 0 |
| O8 | 5 | 1 | 0 | 1 | 0 | 2 | 3 | 18 | 0 |
| O9 | 4 | 0 | 0 | 1 | 1 | 0 | 0 | 1 | 23 |

Once the correlation matrix is determined, a conditional probability of classification C(Oj|Pi) is calculated for every M(Oj, Pi) (814). The conditional probability of classification may be calculated according to equation (1).

$$C ( Oj \vert Pi ) = \frac{M ( Oj , Pi )}{{\sum }_{k} M ( Oj , Pk )} \qquad Equation ( 1 )$$

Table 2 depicts a conditional probability of classification matrix corresponding to the correlation matrix of table 1.

TABLE 2
Conditional Probability of Classification Matrix

| | P1 | P2 | P3 | P4 | P5 | P6 | P7 | P8 | P9 |
|---|---|---|---|---|---|---|---|---|---|
| O1 | 0.5 | 0 | 0 | 0.02 | 0.07 | 0.13 | 0.03 | 0.11 | 0.11 |
| O2 | 0.03 | 0.83 | 0.03 | 0.12 | 0.04 | 0.03 | 0.06 | 0 | 0 |
| O3 | 0 | 0 | 0.8 | 0 | 0.11 | 0 | 0 | 0.04 | 0.07 |
| O4 | 0 | 0 | 0 | 0.73 | 0 | 0 | 0 | 0 | 0 |
| O5 | 0.03 | 0.04 | 0.17 | 0.07 | 0.59 | 0.1 | 0 | 0.04 | 0 |
| O6 | 0.03 | 0.09 | 0 | 0 | 0.11 | 0.65 | 0.1 | 0.04 | 0 |
| O7 | 0.12 | 0 | 0 | 0 | 0.04 | 0.03 | 0.71 | 0.07 | 0 |
| O8 | 0.16 | 0.04 | 0 | 0.02 | 0 | 0.06 | 0.1 | 0.67 | 0 |
| O9 | 0.12 | 0 | 0 | 0.02 | 0.04 | 0 | 0 | 0.04 | 0.82 |

The conditional probabilities are thresholded by a predefined threshold to select high probability pairs of original breed ID and predicted breed ID (816). For example the threshold may select pairs that have a conditional probability above 0.06. For each predicted breed ID, original breed IDs above the threshold value in the conditional probability of classification matrix are used to make a category of the predicted ID (818). The new categories form the sub-category set of the category being trained (820). Each of the sub-categories may then be trained as a category.

Table 3 depicts an illustrative sub-category set.

TABLE 3
Sub-Category Set.

| | Predicted | Original | Conditional |
|---|---|---|---|
| | breed ID | breed ID | Probability |
| Category 1 | 1 | 1 | 0.50 |
| | | 7 | 0.12 |
| | | 8 | 0.16 |
| | | 9 | 0.12 |
| Category 2 | 2 | 2 | 0.83 |
| | | 6 | 0.09 |
| Category 3 | 3 | 3 | 0.80 |
| | | 5 | 0.17 |
| Category 4 | 4 | 2 | 0.12 |
| | | 4 | 0.73 |
| | | 5 | 0.07 |
| Category 5 | 5 | 1 | 0.07 |
| | | 3 | 0.11 |
| | | 5 | 0.59 |
| | | 6 | 0.11 |
| Category 6 | 6 | 1 | 0.13 |
| | | 5 | 0.10 |
| | | 6 | 0.65 |
| | | 8 | 0.06 |
| Category 7 | 7 | 2 | 0.06 |
| | | 6 | 0.10 |
| | | 7 | 0.71 |
| | | 8 | 0.10 |
| Category 8 | 8 | 1 | 0.11 |
| | | 7 | 0.07 |
| | | 8 | 0.67 |
| Category 9 | 9 | 1 | 0.11 |
| | | 3 | 0.07 |
| | | 9 | 0.820 |

From the above, as a category classifier is trained, new sub-categories are generated based on breeds that the classifier consistently classifies as a single predicted ID. A sub-category classifier may then be trained that focuses on attempting to classify the breeds in the sub-category. As an example, from the above, when the classifier predicts an image to be a breed ID of 2, it is likely to have been originally assigned a breed ID of 2 or a breed ID of 6. If the sub-category classifier is not trained further, the classifier can return these breed IDs and probabilities for an image being classified. However, a sub-category classifier may be trained that focuses only on attempting to classify images that have breed IDs of 2 or 6 correctly. In this manner, the hierarchical breed classifier can classify a breed of a pet in an image.

Although specific embodiments are described herein, it will be appreciated that modifications may be made to the embodiments without departing from the scope of the current teachings. Accordingly, the scope of the appended claims should not be limited by the specific embodiments set forth, but should be given the broadest interpretation consistent with the teachings of the description as a whole.

What is claimed is:

1. A method of determining a breed of a pet from an image comprising:
receiving an image depicting a pet's face;
processing the received image with a plurality of classification agents each trained with a respective, different classification algorithm to provide one or more probabilities associated with a breed identifier (ID) indicative of the pet's face being of a particular breed associated with the breed ID; and
consolidating the plurality of probabilities from each of the classification agents to provide final probabilities that the pet's face is associated with respective breed IDs.

2. The method of claim 1, further comprising:
pre-processing the received image to normalize coloring of the image.

3. The method of claim 1, wherein one or more of the classification agents comprise a hierarchical breed classifier for classifying the image as one of a plurality of potential breeds in a hierarchical fashion.

4. The method of claim 3, wherein the hierarchical breed classifier comprises a root category and a plurality of sub-categories, the root classifier classifying the image as one of the sub-categories.

5. The method of claim 4, wherein one or more of the plurality of sub-categories is associated with additional sub-categories.

6. The method of claim 5, wherein each sub-category and additional sub-category, not associated with additional sub-categories, represents a single breed.

7. The method of claim 3, wherein training of the hierarchical breed classifier generates a plurality of sub-categories based on a conditional probability of classification between an originally assigned breed ID and a predicted breed ID of an image.

8. The method of claim 7, wherein sub-category classifiers for each of the plurality of sub-categories generated in training the hierarchical breed classifier are trained using images associated with respective breed IDs of the sub-category.

9. The method of claim 7, wherein each of the plurality of sub-category classifiers uses a different classifier and different feature, said different classifier and different feature being respective to the particular sub-category.

10. The method of claim 1, further comprising:
detecting a location of the pet's face within the image.

11. A system for determining a breed of a pet from an image comprising:
a processing unit for executing instructions;
a memory unit for storing instructions, which when executed by the processing unit configure the system to:
receive an image depicting a pet's face;
process the received image with a plurality of classification agents each trained with a respective different classification algorithm to provide one or more probabilities associated with a breed identifier (ID) indicative of the pet's face being of a particular breed associated with the breed ID; and
consolidate the plurality of probabilities from each of the classification agents to provide final probabilities that the pet's face is associated with respective breed IDs.

12. The system of claim 11, wherein the instructions further configure the system to:
pre-process the received image to normalize coloring of the image.

13. The system of claim 11, wherein one or more of the classification agents comprise a hierarchical breed classifier for classifying the image as one of a plurality of potential breeds in a hierarchical fashion.

14. The system of claim 13, wherein the hierarchical breed classifier comprises a root category and a plurality of sub-categories, the root classifier classifying the image as one of the sub-categories.

15. The system of claim 14, wherein one or more of the plurality of sub-categories is associated with additional sub-categories.

16. The system of claim 13, wherein training of the hierarchical breed classifier generates a plurality of sub-categories based on a conditional probability of classification between an originally assigned breed ID and a predicted breed ID of an image.

17. The system of claim 16, wherein sub-category classifiers for each of the plurality of sub-categories generated in training the hierarchical breed classifier are trained using images associated with respective breed IDs of the sub-category.

18. The system of claim 16, wherein each of the plurality of sub-category classifiers uses a different classifier and different feature, said different classifier and different feature being respective to the particular sub-category.

19. The system of claim 11, wherein the instructions further configure the system to:
detect a location of the pet's face within the image.

20. A non-transitory computer readable medium storing instructions for execution by a processor to configure a system to:
receive an image depicting a pet's face;
process the received image with a plurality of classification agents each trained with a respective different classification algorithm to provide one or more probabilities associated with a breed identifier (ID) indicative of the pet's face being of a particular breed associated with the breed ID; and
consolidate the plurality of probabilities from each of the classification agents to provide final probabilities that the pet's face is associated with respective breed IDs.
